(19) United States
(12) Patent Application Publication
(10) Pub. No.: US 2025/0346082 A1
(43) Pub. Date: Nov. 13, 2025

(54) ACTIVE SUSPENSION ACTUATOR WITH REDUCED REFLECTED INERTIA

(71) Applicant: GM GLOBAL TECHNOLOGY OPERATIONS LLC, Detroit, MI (US)

(72) Inventors: Brian K. Saylor, South Lyon, MI (US); Robert Patrick Marble, White Lake, MI (US)

(73) Assignee: GM GLOBAL TECHNOLOGY OPERATIONS LLC, Detroit, MI (US)

(21) Appl. No.: 18/659,839

(22) Filed: May 9, 2024

(51) Int. Cl. B60G 17/015

(52) U.S. Cl. CPC B60G 17/015; B60G 2600/182

(57) ABSTRACT

Disclosed is a product that may include an active suspension power system comprising at least one of a motor or a mass connected to a first side of a clutch and a movable arm connected to a second side of the clutch.

The technical field generally relates to active suspension actuator system for a vehicle, compartments thereof, and methods of using the same.

### BACKGROUND

The need for improved ride and handling is pushing the limits and capability of passive and adaptive suspension devices. Active suspension is the pinnacle of technology in the chassis that can enable optimal ride and handling. However, active suspension components are typically high power consumers and are very heavy. These active suspension components have motors and/or gear sets that are required to have sufficient size and mass to control body motion. The active suspension components typically add mass to the unsprung mass of the vehicle which is detrimental to the ride and isolation properties of the suspension. With such a large mass, there is an inherent reflected inertia that has a negative influence on the right isolation possible in the suspension system.

It is desirable to provide an active suspension that has at selective times a significantly reduced mass relative to prior systems and will have a less negative impact on the isolation of the suspension system. Furthermore, other desirable features and characteristics of the variations disclosed herein will become apparent from the subsequent detailed description and the appended claims, taken in conjunction with the accompanying drawings and the foregoing.

### SUMMARY

A number of variations may include a product including: an active suspension power system including at least one of a motor or a mass connected to a first side of a clutch and a movable arm connected to a second side of the clutch.

A number of variations may include a product wherein the active power suspension includes a motor connected to the first side of the clutch.

A number of variations may include a product wherein the active power suspension further includes a mass connected to the first side of the clutch.

A number of variations may include a product wherein the motor is directly or indirectly connected to the first side of clutch.

A number of variations may include a product wherein the motor is connected to the mass via a belt.

A number of variations may include a product further including a first shaft connected to a first side of the clutch and connected to at least one of the motor or the mass.

A number of variations may include a product wherein the motor is directly connected to the first shaft.

A number of variations may include a product wherein the motor includes a second shaft, and further including a belt operatively connected to the second shaft and to the mass to rotate the mass.

A number of variations may include a product wherein the clutch is constructed and arranged to selectively decouple the movable arm from the at least one of the motor or the mass, to selectively rotate the movable arm in a first direction, and to selectively rotate the movable arm in a second direction.

A number of variations may include a product further including a vehicle strut directly or indirectly connected to the movable arm.

A number of variations may include a product wherein the clutch includes an epicyclic gear train.

A number of variations may include a product wherein the clutch includes a plurality of planetary gear sets.

A number of variations may include a product wherein the clutch includes a bidirectional magnetorheological fluid clutch.

A number of variations may include a product wherein the motor is directly connected to a first shaft.

A number of variations may include a product wherein the mass is connected to the first shaft.

A number of variations may include a product further including an elongated link pivotally connected to the movable arm and the strut.

A number of variations may include a product including: an active suspension power system including at least one of a motor or a mass connected to a first side of a clutch and a movable arm connected to a second side of the clutch, wherein the clutch is constructed and arranged to selectively decouple the movable arm from the at least one of the motor or the mass, to selectively rotate the movable arm in a first direction, and to selectively rotate the movable arm in a second direction.

A number of variations may include a product wherein the clutch includes an epicyclic gear train, a plurality of planetary gear sets, or a bidirectional magnetorheological fluid clutch.

A number of variations may include a product further including a vehicle strut connected to the movable arm.

A number of variations may include a system including: an active suspension power system including at least one of a motor or a mass connected to a first side of a clutch and a movable arm connected to a second side of the clutch, wherein the clutch is constructed and arranged to selectively decouple the movable arm from the at least one of the motor or the mass, to selectively rotate the movable arm in a first direction, and to selectively rotate the movable arm in a second direction, a vehicle strut connected to the movable arm, the strut connected to a vehicle wheel, a wheel vertical movement sensor operatively connected to the vehicle wheel, the sensor and clutch operatively connected to communication with a special-purpose computer including electronic processor, non-transitory memory having written instructions stored thereon and executable by the electronic processor to carry out the functionality of receiving data from the sensor and controlling the clutch.

### BRIEF DESCRIPTION OF THE DRAWINGS

The variations will hereinafter be described in conjunction with the following drawing figures, wherein like numerals denote like elements, and wherein:

FIG. 1 illustrates a product including an active suspension actuator with reduced reflected inertia according to a number of variations;

FIG. 2 illustrates a product including an active suspension actuator with reduced reflected inertia according to a number of variations;

FIG. 3 illustrates a product including an active suspension actuator with reduced reflected inertia according to a number of variations;

FIG. 4 illustrates a product including a portion of an active suspension actuator with reduced reflected inertia according to a number of variations;

FIG. 5 illustrates a product including a clutch including an epicyclical train useful in an active suspension actuator with reduced reflective inertia according to a number of variations;

FIG. 6 illustrates a product including a clutch including a plurality of planetary gear sets useful in an active suspension actuator with reduced reflective inertia according to a number of variations;

FIG. 7 illustrates a product including a bidirectional magnetorheological clutch useful in an active suspension actuator with reduced reflective inertia according to a number of variations; and

FIG. 8 is a schematic illustration of a vehicle including an active suspension actuator with reduced reflective inertia according to a number of variations.

### DETAILED DESCRIPTION

The following detailed description is merely illustrative in nature and is not intended to limit the application and uses. Furthermore, there is no intention to be bound by any expressed or implied theory presented in the preceding technical field, background, brief summary or the following detailed description.

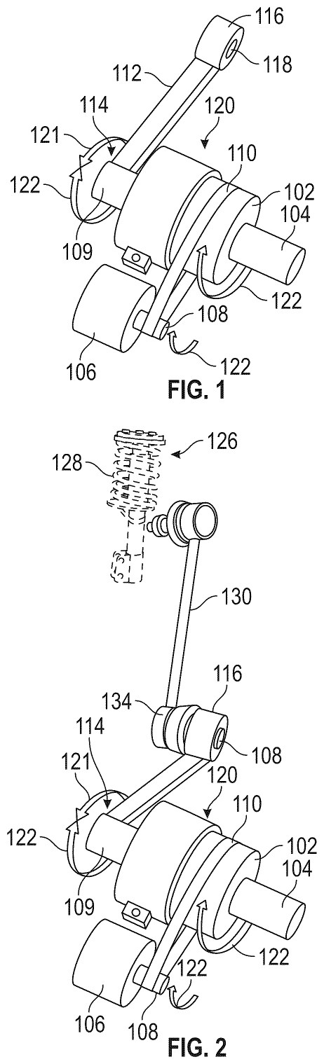

A number of variations are illustrated in FIGS. 1-2, which may include a product which may include a rotatable mass 102 on a first shaft 104. A motor 106 may have a second shaft 108. A belt 110 may be connected to the second shaft 108 and to the rotatable mass 102 so that as the motor 106 turns the second shaft 108 in a first direction 122, which may be clockwise when viewed from the first shaft 121 to the motor 106, the belt 110 turns the rotatable mass 102 in the first direction 122. The first shaft 104 may be connected to a first side of a clutch 120. The term “clutch” as used herein means a mechanical device that allows an output shaft to be disconnected from the rotating input shaft. The input shaft of the clutch may be directly or indirectly attached or connected to a motor, while the output shaft of the clutch may be connected to the mechanism that does the work, for example but not limited to, the movable arm 112 or other mechanical component to assist a suspension component in moving in response to a vehicle tire engaging features in a driving surface. A second side of the clutch 120 may be connected to a third shaft 109. Movable arm 112 may be provided having a first end 114 connected to the third shaft 109, and a second end 116 which may have a through hole 118 formed therein. In a number of variations, an elongated link 130 may be provided having a first end 132 pivotally connected to the movable arm 112 by a projection (not shown) extending into the through hole 118 formed in the second end 116 of the movable arm 112. A second end 134 of the elongated link 130 may be pivotally connected to a suspension component, such as but not limited to, a strut 126 having a spring 128.

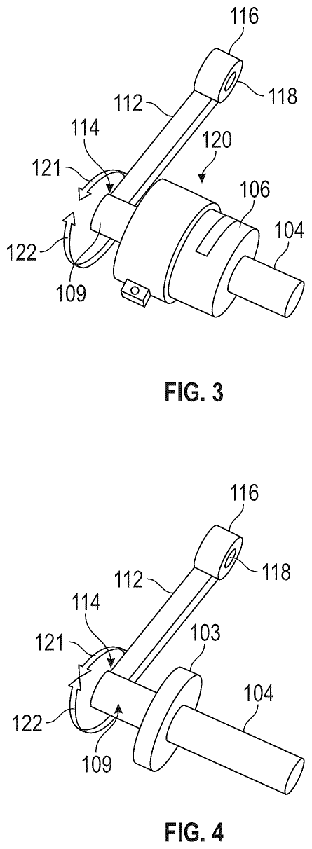

A number of variations are illustrated in FIG. 3, which may include a motor driving a first shaft 104 connected to a first set of a clutch 120. The motor 106 serves as both the power and the mass and is connected to the first side of the clutch 120. A second shaft 108 connected to the other side of the clutch 120. The movable arm 112 has a first end 114 connected to the second shaft 108. The second end 116 end may have a through hole 118 formed therein. The clutch 120 may be operated to decouple the motor 106 and the first shaft 104 from the movable arm 112, or to move the movable arm 112 a first direction 122 or an opposite direction 124.

A number of variations are illustrated in FIG. 4 wherein a relatively small mass 103 may be secured to the first shaft 104 which may be driven by a motor (not shown) to operate the movable arm 112 as described with respect to FIG. 3.

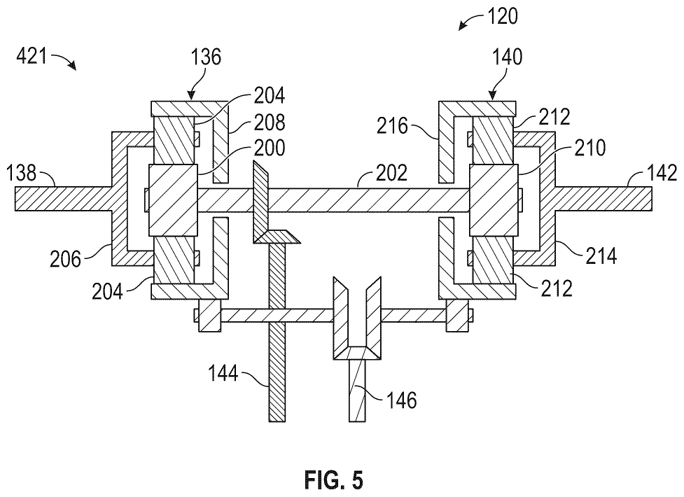

In a number of variations, the clutch 120 may be a bidirectional clutch known to persons skilled in the art. A number of suitable bidirectional clutch are commercially and may be operated so that the output shaft may be selectively engaged or not engaged so that the output shaft does not rotate, rotates clockwise or rotates counterclockwise. For example a suitable bidirectional clutch is available from Carlyle Johnson under the name Bi-Directional One-Way Clutch (MTL). U.S. Pat. No. 1,363,004, issued Dec. 12, 1920, to Carl E. Johnson discloses a suitable three bevel gear system and a clutch mechanism suitable for use as a bidirectional clutch in the active suspension power system disclosed herein, wherein a clutch coupling may be splined to a shaft and moveable to three positions including a first position wherein the clutch coupling does not engage either of a first bevel gear or a second bevel gear that are receive on the shaft and are each driven by a third bevel gear so that the output shaft does not rotate, and moveable to a second position wherein the clutch coupling engages the first bevel gear to rotate the output shaft in a clockwise direction (or forward direction) and moveable to a third position wherein the clutch coupling engages the second bevel gear to rotate the output shaft in a counterclockwise direction (or reverse direction). Other bidirectional clutches may be utilized. For example, a clutch 120 used for differential steering as illustrated in FIG. 5, which may include a first epicyclic gear train 421 including a first epicyclic gear 136 and a second epicyclic gear 140. The first epicyclic gear 136 may include a first sun gear 200 operatively connected to at least two first planet gears 204, a first planet carrier 206 may be connected to the at least two first planet gears 204, and a first ring gear 208 may be connected to the at least two first planet gears 204. A first output shaft 138 may be connected to the first planet carrier 206.

The second epicyclic gear 140 may include a second sun gear 210, which may be operatively connected to at least two second planet gears 212, a second planet carrier 214 may be connected to the at least two second planet gears 212, and a second ring gear 216 may be connected to the at least two second planet gears 212. A second output shaft 142 may be connected to the second planet carrier 214.

A sun gear input shaft 202 may be connected to the first sun gear 200 and the second sun gear 210. A drive input shaft 144 may be connected to a motor 106 (shown in FIGS. 1-3, and 8). The steering input 146 and components connecting to the first ring gear 208 and second ring gear 216 shown in FIG. 5 may be eliminated. One or more of the components of the first epicyclic gear 136 and second epicyclic gear 140 may be allowed to move or rotate or be held stationary to cause the first output shaft 138 and the second output shaft 142 to not rotate; or cause the first output shaft 138 to rotate in a first direction (such as, clockwise looking at the first planet carrier 206) and not allowing the second output shaft 142 to rotate; or cause the second output shaft 142 to rotate in an opposite direction (such as, clockwise looking at the second planet carrier 214) and not allowing the first output shaft 138 to rotate. The first output shaft 138 and the second output shaft 142 may be connected to the movable arm 112 shown in FIGS. 1-4, for example, by a concentric connection or in a side arrangement along the length of the movable arm 112.

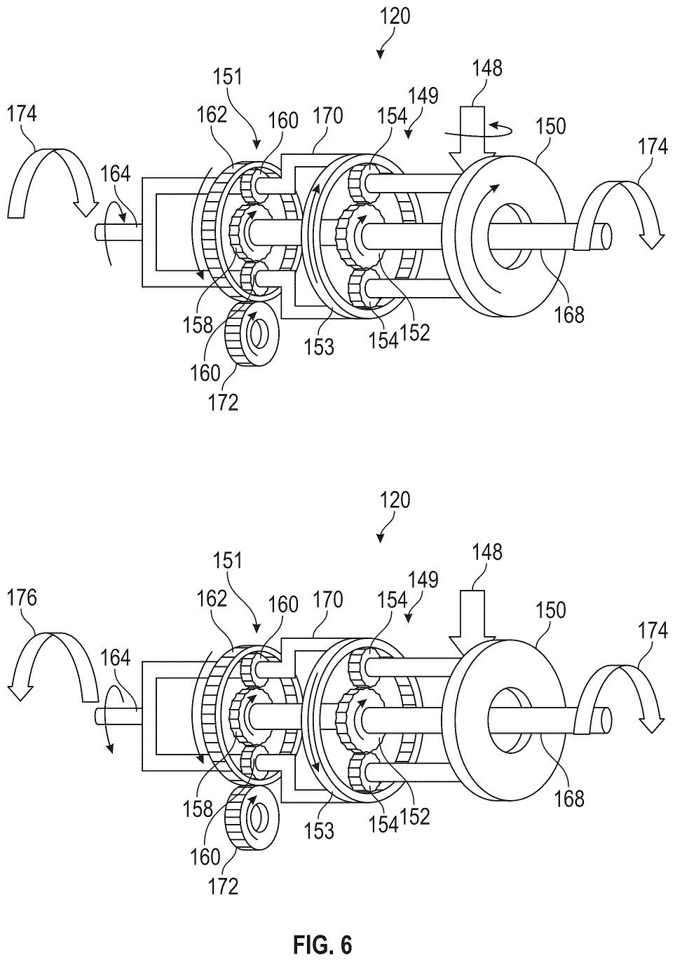

Another example of a clutch suitable for coupling or decoupling the motor 106 and rotatable mass 102 to or from the movable arm 112 (shown in FIGS. 1-4) is illustrated in FIG. 6. A third input shaft 148 may be geared to drive a third planet carrier 150. The third planet carrier 150 may support a third pair of planet gears 154 of a first planetary gear set 149. The first planetary gear set 149 may also include a third ring gear 153 engaging the third pair of planet gears 154, and a third sun gear 152 may engage the third pair of planet gears 154. A third shaft 168 may be connected to the third sun gear 152.

A second planetary gear set 151 may be provided including a fourth pair of planet gears 160 driven by a second set of shafts 170 connected to the third ring gear 153 of the first planetary gear set 149. The second planetary gear set 151 may include a fourth sun gear 158 attached to the third shaft 168. A fourth ring gear 162 may engage the fourth set of planet gears 160. In input gear 172 may be connected to the fourth ring gear 162. A third output shaft 164 may be connected to the fourth ring gear 162. One or more of the components of the first planetary gear set 149 and second planetary gear set 151 may be allowed to move or rotate or be held stationary to cause the third output shaft 164 to not rotate; or cause the third output shaft 164 to rotate in a first direction 174 (such as, clockwise looking); or causing the third output shaft 164 to rotate in an opposite direction 176 (such as, clockwise).

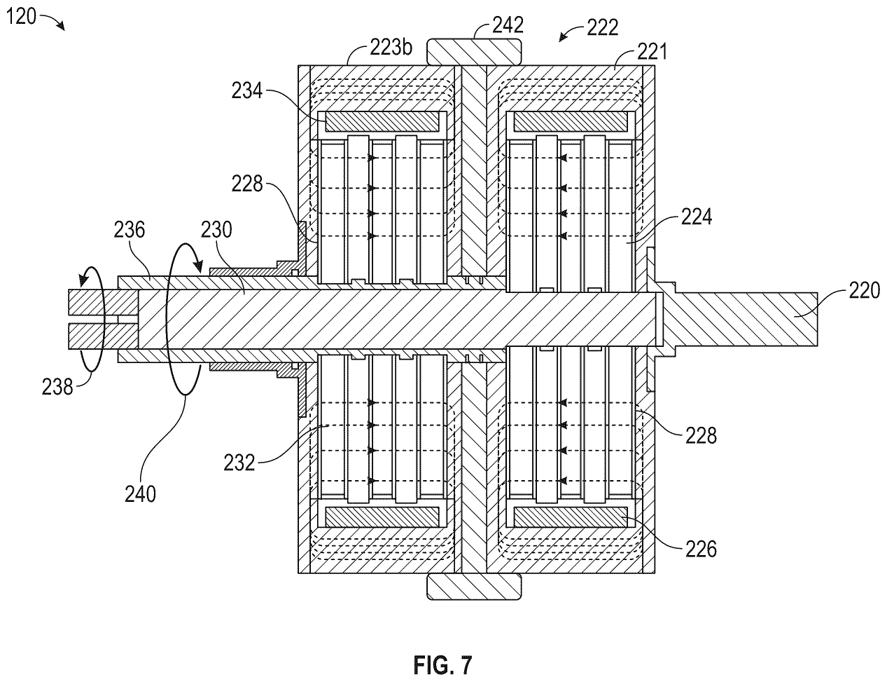

A number of variations are illustrated in FIG. 7 wherein the clutch 120 is a bidirectional magnetorheological fluid clutch. The clutch 120 may include a casing shaft 220 which may be connected to a casing 222 having a first portion 221 and a second portion 223. The first portion 221 may include an electrically conductive first coil 226 and a magnetorheological fluid 228. A first rotor 224 may be splined to a first rotor shaft 230. A nonmagnetic partition 242 may separate the first portion 221 and the second portion 223 of the casing 222. The second portion 223 may include a second coil 234 and a magnetorheological fluid 228. A second rotor 232 may be splined to a second shaft 236. The first coil 226 or the second coil 234 may be selectively energized to rotate an output shaft clockwise or counterclockwise.

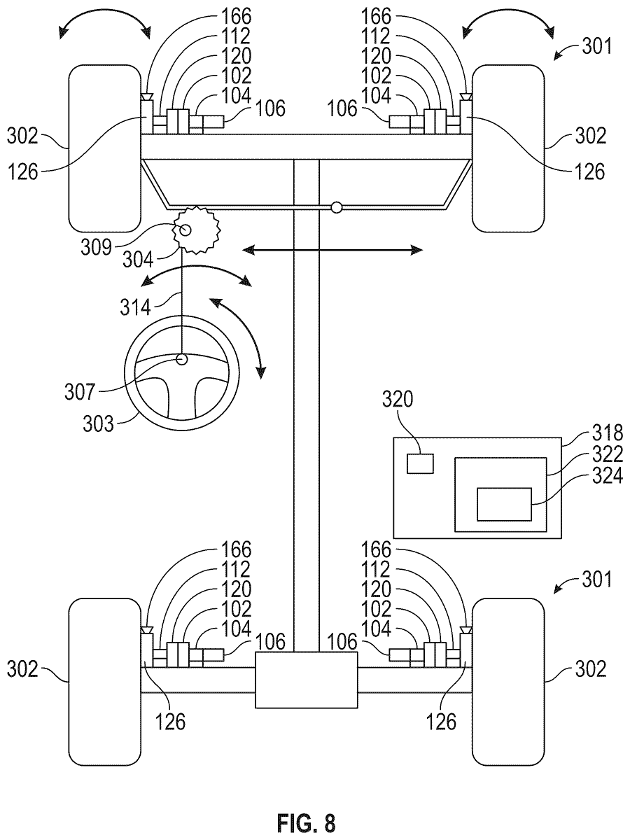

A number of variations are illustrated in FIG. 8 which is a schematic illustration of a vehicle 301 including a wheel 302, for example four wheels, and a strut 126 connected to the wheel 302. A sensor 166 may be provided to determine at least one of vertical, longitudinal, or lateral movement of an associated wheel 302. A first shaft 104, a rotatable mass 102, a clutch 120 and a movable arm 112 may be operatively connected to the strut 126 at each one of wheels 302. A motor 106 may be directly or indirectly connected to the rotatable mass 102 or the first shaft 104. The clutch 120 may disconnect the rotatable mass 102 or motor 106 from the movable arm 112 or provide a connection to the movable arm 112 to rotate the movable arm 112 in a first direction 238 or a second opposite direction 240 to assist the strut 126 to move up or down as desired in response to data from the sensor 166. The sensor 166 may be operatively connected to a special-purpose computer 318 including an electronic processor 320 and non-transitory memory 322 having written instructions 324 stored thereon which are executable by the electronic processor 320 to carry out one or mor of the functionalities described herein. The vehicle may also include a steering interface 303 and a steering angle sensor 307 operatively connected thereto, and wherein the steering interface 303 is connected to a pinion gear 304 having a pinion gear sensor 309 associated therewith. The pinion gear 304 may be connected to a steering rack 305 having a steering rack sensor 310. associated therewith. The motor 106, the clutch 120, and the sensor 166 may be in operative communication with a special-purpose computer 318 including the electronic processor 320, non-transitory memory 322 having written instructions 324 stored thereon for receiving data from the sensor 166 and controlling the clutch 120 and motor 106.

While at least one illustrative variation has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A product comprising:
an active suspension power system comprising at least one of a motor or a mass connected to a first side of a clutch and a movable arm connected to a second side of the clutch.

2. The product as set forth in claim 1 wherein the active suspension power comprises system the motor connected to the first side of the clutch.

3. The product as set forth in claim 2 wherein the active power suspension further comprises the mass connected to the first side of the clutch.

4. The product as set forth in claim 2 wherein the motor is directly or indirectly connected to the first side of clutch.

5. The product as set forth in claim 3 wherein the motor is connected to the mass via a belt.

6. The product as set forth in claim 1 further comprising a first shaft connected to a first side of the clutch and connected to at least one of the motor or the mass.

7. The product as set forth in claim 6 wherein the motor is directly connected to the first shaft.

8. The product as set forth in claim 6 wherein the motor includes a second shaft, and further comprising a belt operatively connected to the second shaft and to the mass to rotate the mass.

9. The product as set forth in claim 1 wherein the clutch is constructed and arranged to selectively decouple the movable arm from the at least one of the motor or the mass, to selectively rotate the movable arm in a first direction, and to selectively rotate the movable arm in a second direction.

10. The product as set in claim 9 further comprising a vehicle strut directly or indirectly connected to the movable arm.

11. The product as set forth in claim 9 wherein the clutch comprises an epicyclic gear train.

12. The product as set forth in claim 9 wherein the clutch comprises a plurality of planetary gear sets.

13. The product is set forth in claim 9 wherein the clutch comprises a bidirectional magnetorheological fluid clutch.

14. The product as set forth in claim 9 wherein the motor is directly connected to a first shaft.

15. The product as set forth in claim 14 wherein the mass is connected to the first shaft.

16. The product is set forth in claim 10 further comprising an elongated link pivotally connected to the movable arm and the strut.

17. A product comprising:
an active suspension power system comprising at least one of a motor or a mass connected to a first side of a clutch and a movable arm connected to a second side of the clutch, wherein the clutch is constructed and arranged to selectively decouple the movable arm from the at least one of the motor or the mass, to selectively rotate the movable arm in a first direction, and to selectively rotate the movable arm in a second direction.

18. The product as set forth in claim 17 wherein the clutch comprises an epicyclic gear train, a plurality of planetary gear sets, or a bidirectional magnetorheological fluid clutch.

19. The product as set forth in claim 17 further comprising a vehicle strut connected to the movable arm.

20. A system comprising:
an active suspension power system comprising at least one of a motor or a mass connected to a first side of a clutch and a movable arm connected to a second side of the clutch, wherein the clutch is constructed and arranged to selectively decouple the movable arm from the at least one of the motor or the mass, to selectively rotate the movable arm in a first direction, and to selectively rotate the movable arm in a second direction, a vehicle strut connected to the movable arm, the strut connected to a vehicle wheel, a wheel vertical movement sensor operatively connected to the vehicle wheel, the sensor and clutch operatively connected to communication with a special-purpose computer including electronic processor, non-transitory memory having written instructions stored thereon and executable by the electronic processor to carry out the functionality of receiving data from the sensor and controlling the clutch.
